(19) United States
(12) Patent Application Publication
(10) Pub. No.: US 2026/0187865 A1
(43) Pub. Date: Jul. 2, 2026

(54) CONTENT DISPLAY METHOD AND APPARATUS, ELECTRONIC DEVICE, AND COMPUTER-READABLE STORAGE MEDIUM

(71) Applicant: SHENZHEN TCL CREATIVE CLOUD TECHNOLOGY CO., LTD., Shenzhen, Guangdong (CN)

(72) Inventor: Peng WANG, Shenzhen, Guangdong (CN)

(73) Assignee: SHENZHEN TCL CREATIVE CLOUD TECHNOLOGY CO., LTD., Shenzhen, Guangdong (CN)

(21) Appl. No.: 19/125,304

(22) PCT Filed: Aug. 3, 2023
(86) PCT No.: PCT/CN2023/110902

§ 371 Date: Apr. 28, 2025

(30) Foreign Application Priority Data
Nov. 1, 2022 (CN) 202211358697.0

(51) Int. Cl. G06T 11/10; G06T 7/90

(52) U.S. Cl. CPC G06T 11/10; G06T 7/90; G06T 2207/10024

(57) ABSTRACT

The present disclosure discloses a content display method and apparatus, an electronic device, and a computer-readable storage medium. In the present disclosure, after RGB information is converted into target color space information according to a color blindness type, brightness adjustment is performed on a brightness value of the target color space information according to an original brightness value to acquire adjusted target color space information, and the loss degree of the brightness value in the adjusted target color space information is reduced, such that abnormal brightness of content to be displayed is avoided when said content is displayed according to the adjusted target color space information.

This application claims the priority of Chinese Patent Application No. 202211358697.0, entitled “CONTENT DISPLAY METHOD AND APPARATUS, ELECTRONIC DEVICE, AND COMPUTER-READABLE STORAGE MEDIUM”, filed on Nov. 1, 2022, the disclosure of which is incorporated herein by reference in its entirety.

### FIELD OF THE DISCLOSURE

The present disclosure relates to the field of display technology, and in particular to a content display method, device, electronic device and computer-readable storage medium.

### BACKGROUND

With the development of science and technology, the application fields of display devices are becoming more and more extensive. Since display devices generally use RGB (red, blue and green) display technology to display the content to be displayed, and color-blind users cannot distinguish at least one color in RGB, in order to help color-blind users better see the colorful pictures, the RGB data of the displayed content will be adjusted in color, and the content to be displayed will be displayed based on the adjusted RGB data.

However, when color adjustment is performed on RGB data, brightness information of the RGB data is lost, resulting in abnormal brightness of display content displayed according to the adjusted RGB data.

### Technical Problem

A technical issue where the brightness of the displayed content is abnormal based on the adjusted RGB data.

### Technical Solutions

An embodiment of the present disclosure provides a content display method. The content display method includes:
acquiring RGB information of content to be displayed by an electronic device, and acquiring the color blindness type of a current user of the electronic device;
converting the RGB information into target color space information based on the color blindness type;
acquiring original brightness value corresponding to the RGB information;
adjusting brightness value of the target color space information to acquire adjusted target color space information according to the original brightness value; and
converting the adjusted target color space information into target RGB information of the content to be displayed, and displaying the content to be displayed according to the target RGB information.

Accordingly, an embodiment of the present disclosure provides a content display device. The content display device includes:
an information acquisition module, configured to RGB information of content to be displayed by an electronic device, and to acquire the color blindness type of a current user of the electronic device;
an information conversion module, configured to convert the RGB information into target color space information based on the color blindness type;
a brightness acquisition module, configured to acquire original brightness value corresponding to the RGB information;
a brightness adjustment module, configured to adjust brightness value of the target color space information to acquire adjusted target color space information according to the original brightness value;
a content display module, configured to convert the adjusted target color space information into target RGB information of the content to be displayed, and displaying the content to be displayed according to the target RGB information.

In addition, another embodiment of the present disclosure further provides an electronic device, including a processor and a memory. The memory stores computer program executable by the processor to perform the content display method provided in the embodiment of the present disclosure.

In addition, another embodiment of the present disclosure further provides a computer-readable storage medium storing computer program executable by a processor to perform the content display method provided in the embodiment of the present disclosure.

In addition, another embodiment of the present disclosure further provides a computer program product including computer program. When the computer program is executed by a processor, any content display method provided in the embodiment of the present disclosure is implemented.

### Advantageous Effects

In an embodiment of the present disclosure, RGB information of content to be displayed on an electronic device is obtained, and the color blindness type of a current user of the electronic device is obtained; according to the color blindness type, the RGB information is converted into target color space information; the original brightness value corresponding to the RGB information is obtained; according to the original brightness value, the brightness value of the target color space information is adjusted to acquire the adjusted target color space information; the adjusted target color space information is converted into the target RGB information of the content to be displayed, and according to the target RGB information, the content to be displayed is displayed.

In an embodiment of the present disclosure, after converting the RGB information into target color space information according to the type of color blindness, the brightness value of the target color space information is adjusted according to the original brightness value to acquire the adjusted target color space information, thereby reducing the degree of loss of the brightness value in the adjusted target color space information, so that when the content to be displayed is displayed according to the adjusted target color space information, the brightness abnormality of the content to be displayed is avoided.

### BRIEF DESCRIPTION OF THE DRAWINGS

In order to more clearly illustrate the technical solutions in the embodiments of the present disclosure, the drawings required to be used in the description of the embodiments will be briefly introduced below, and it is obvious that the drawings described below are only some embodiments of the present disclosure, and for those skilled in the art, other drawings can be acquired according to these drawings without creative labor.

FIG. 1 illustrates a flow chart of a content display method according to an embodiment of the present disclosure.

FIG. 2 illustrates a flow chart of another content display method according to an embodiment of the present disclosure.

FIG. 3 illustrates a schematic diagram of the structure of a content display device according to an embodiment of the present disclosure.

FIG. 4 illustrates a block diagram of an electronic device according to an embodiment of the present disclosure.

### DETAILED DESCRIPTION OF THE PRESENT DISCLOSURE

the implementation description paragraph of this application here.

The following will be combined with the drawings in the embodiments of the present disclosure to clearly and completely describe the technical solutions in the embodiments of the present disclosure. Obviously, the described embodiments are only part of the embodiments of the present disclosure, not all of the embodiments. Based on the embodiments in the present disclosure, all other embodiments obtained by those skilled in the art without creative work are within the scope of protection of this application.

The embodiments of the present disclosure provide a content display method, device, electronic device and computer-readable storage medium. The content display device can be integrated in an electronic device, which can be a server or a terminal.

The server can be an independent physical server, a server cluster or a distributed system composed of multiple physical servers, or a cloud server that provides cloud services, cloud databases, cloud computing, cloud functions, cloud storage, network services, cloud communications, middleware services, domain name services, security services, network acceleration services (Content Delivery Network, CDN), and basic cloud computing services such as big data and artificial intelligence platforms. Terminals can be smartphones, tablets, laptops, desktop computers, smart speakers, smart watches, etc., but they are not limited to that. Terminals and servers may be connected directly or indirectly by wired or wireless communication, and the present disclosure is not limited herein.

The terminal may be a smart phone, a tablet computer, a laptop computer, a desktop computer, a smart speaker, a smart watch, etc., but is not limited thereto. The terminal and the server may be directly or indirectly connected via wired or wireless communication, and this application does not limit this.

In addition, the term “plurality” in the embodiments of the present disclosure refers to two or more than two. The terms “first” and “second” in the embodiments of the present disclosure are used to distinguish descriptions and should not be understood as implying relative importance.

It should be noted that the description order of the following embodiments is not intended to limit the preferred order of the embodiments.

In this embodiment, the description will be made from the perspective of the content display device. In order to facilitate the description of the content display method of the present disclosure, the following detailed description will be given with the content display device integrated in the terminal, that is, with the terminal as the execution subject.

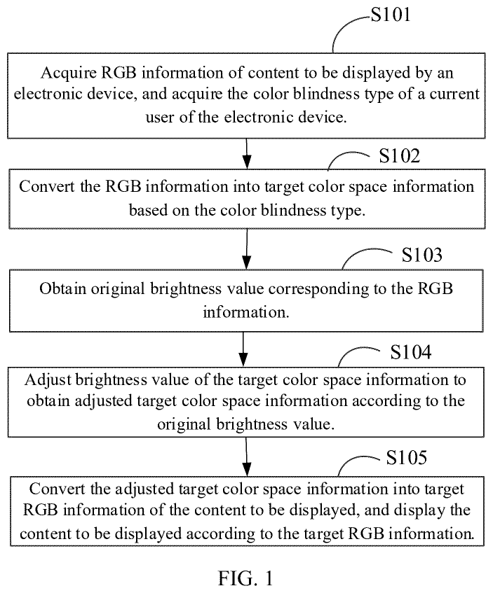

Please refer to FIG. 1 illustrating a flow chart of a content display method according to an embodiment of the present disclosure. The content display method may include:

S101: Acquire RGB information of content to be displayed by an electronic device, and acquire the color blindness type of a current user of the electronic device.

The content to be displayed refers to the object to be displayed on the electronic device. Optionally, the content to be displayed may be content that has been displayed on the electronic device, or may be content that will be displayed on the electronic device. This example is not limited here. The type of the content to be displayed may be at least one of text and picture.

RGB information refers to information about various colors obtained by changing the three color channels of red (R), green (G), and blue (B) and superimposing them on each other.

The color blindness type of the current user refers to colors that the current user cannot distinguish, which may include at least one of tritanopia, protanopia, and deuteranopia.

The terminal may have stored the color blindness type of the current user, and in this case, the terminal may directly obtain the color blindness type of the current user from the terminal. When the terminal does not store the color blindness type of the current user, the terminal may display a color blindness type input interface, and then obtain the color blindness type of the current user in response to a trigger operation of the current user on the color blindness type input interface.

The terminal may first obtain the color blindness type of the current user, and then obtain the RGB information of the content to be displayed, or the terminal may first obtain the RGB information of the content to be displayed, and then obtain the color blindness type of the current user, or the terminal may obtain the color blindness type of the current user while acquiring the RGB information of the content to be displayed. This embodiment is not limited here.

S102: Convert the RGB information into target color space information based on the color blindness type.

A color space refers to a method of describing colors in a generally acceptable manner under certain standards. A target color space refers to a pre-set color space for converting RGB information. The target color space can be selected according to actual conditions. For example, the target color space can be an HSV color space, or the target color space can be a YUV color space. This is not limited in this embodiment.

In some embodiments, according to the type of color blindness, the process of converting RGB information into target color space information includes:
adjusting color information corresponding to the color blindness type in the RGB information to acquire an adjusted RGB information;
converting the adjusted RGB information into initial target color space information;
converting the RGB information into normal target color space information;
determining the target color space information according to the normal target color space information and the initial target color space information.

Converting the RGB information into normal target color space information can be understood as directly converting the RGB information into information in the target color space without adjusting the RGB information and then converting the adjusted RGB information into initial target color space information.

For example, when the target color space is the HSV color space and the color blindness type is green blindness, first obtain the R channel information R, the G channel information G and the B channel information B from the RGB information, and then directly convert R, G and B into HSV information. However, since the color blindness type is green blindness, G is adjusted to acquire the adjusted RGB information, and then the adjusted RGB information is converted into HSV information.

The process of adjusting the color information corresponding to the color blindness type in the RGB information to acquire the adjusted RGB information may be:

The color information corresponding to the color blindness type in the RGB information is adjusted to a first target value to acquire adjusted RGB information.

The first target value may be selected according to actual conditions. For example, the first target value may be 0 or 0.1, which is not limited in this embodiment.

When the first target value is 0, the target color space is the HSV color space, and the color blindness type is green blindness, the normal information of the HSV color space includes H=(R, G, B), S=(R, G, B), and V=(R, G, B), and the initial target color space information includes h=(R, 0, B), s=(R, 0, B), and v=(R, 0, B).

H=(R,G,B) can be understood as performing a conversion operation on R, G and B to acquire H, and h=(R,0,B) can be understood as performing a conversion operation on R, 0 and B to acquire h.

The following is an exemplary description of the process of converting R, G and B to acquire H, S and V. First, normalize R, G and B to acquire normalized R, normalized G and normalized B, and then solve the maximum and minimum values between normalized R, normalized G and normalized B. When the maximum value is equal to the minimum, H is equal to 0°. When the maximum value is equal to the normalized R, His determined according to the difference between the maximum value and the minimum value, normalized G, normalized B and the preset degree. When the maximum value is equal to the normalized G, H is determined according to the difference between the maximum value and the minimum value, normalized B, normalized R and the preset degree. When the maximum value is equal to the normalized B, His determined according to the difference between the maximum value and the minimum value, normalized G, normalized R and the preset degree. That is, at this time, H can be determined by the following relationship:

$$H \{ \begin{matrix}0 ° & β = 0 \\ 60 ° \times ( \frac{{G}^{′} - {B}^{′}}{β} + 0 ) & C max = {R}^{′} \\ 60 ° \times ( \frac{{B}^{′} - {R}^{′}}{β} + 2 ) & C max = {G}^{′} \\ 60 ° \times ( \frac{{R}^{′} - {G}^{′}}{β} + 4 ) & C max = {B}^{′}\end{matrix}$$

where R′ represents normalized R, i.e., R′=R/255, G′ represents normalized G, i.e., G′=G/255, B′ represents normalized B, that is, B′=B/255, Cmax represents the maximum value among normalized R, normalized G and normalized B, i.e., Cmax=max (R′,G′,B′), Cmin represents the minimum value among normalized R, normalized G and normalized B Cmin=min (R′,G′,B′), β represents the difference between the maximum value and the minimum value, i.e., β=Cmax−Cmin, and 60° represents the preset degree.

When the maximum value is equal to 0, then S is equal to 0. When the maximum value is not equal to 0, S is determined according to the difference between the maximum value and the minimum value and the maximum value. That is, S can be determined by the following relationship:

$$S = \{ \begin{matrix}0 & C max = 0 \\ \frac{β}{C max} & C max \neq 0\end{matrix}$$

V is equal to the maximum value, that is, V=Cmax.

The process of determining h, s and v may refer to the process of determining H, S and V, which will not be described in detail in this embodiment.

Alternatively, the adjusting color information corresponding to the color blindness type in the RGB information to acquire the adjusted RGB information comprises:
determining the color information corresponding to the color blindness type in the RGB information;
acquiring the color blindness level corresponding to the color blindness type; and
adjusting the color information corresponding to the color blindness type in the RGB information to acquire the adjusted RGB information according to the color blindness level.

In this embodiment, the color information corresponding to the color blindness type in the RGB information is not directly adjusted to the first target value. Instead, the color information corresponding to the color blindness type in the RGB information is adjusted according to the color blindness level to acquire the adjusted RGB information. The degree of adjustment of the color information corresponding to the color blindness type in the RGB information is different for different color blindness levels, thereby improving the accuracy of the adjusted RGB information.

In some embodiments, determining the target color space information according to the normal target color space information and the initial target color space information includes:

A difference operation is performed on the normal target color space information and the initial target color space information to acquire the target color space information, wherein the difference operation is an operation to determine the difference between the normal target color space information and the initial target color space information, and the type of the difference operation can be selected according to actual conditions, for example, the difference operation can be a subtraction operation or a division operation, which is not limited in this embodiment.

In some embodiments, determining the determining the target color space information according to the normal target color space information and the initial target color space information comprises:
acquiring a first weight corresponding to the normal target color space information and a second weight corresponding to the initial target color space information;
performing a fusion process on the first weight and the normal target color space information to acquire a first fusion result corresponding to the normal target color space information;
performing a fusion process on the second weight and the initial target color space information to acquire a second fusion result corresponding to the initial target color space information; and
determining the target color space information according to the first fusion result and the second fusion result.

After acquiring the first fusion result and the second fusion result, the terminal may perform a subtraction operation on the first fusion result and the second fusion result to acquire the target color space information, or may perform a division operation on the first fusion result and the second fusion result to acquire the target color space information. That is, the target color space information may include Hg, Sg, and Vg, where Hg=f(H,h), Sg=f(S,s), Vg=f(V,v), and f( ) represents a subtraction operation or a division operation.

In this embodiment, the normal target color space information and the initial target color space information correspond to different weights respectively, so that the normal target color space information and the initial target color space information are adjusted according to the weights, so that the obtained target color space information is more accurate.

The first weight and the second weight may be fixed, or, in order to acquire the target color space information more accurately, in other embodiments, the acquiring the first weight corresponding to the normal target color space information and the second weight corresponding to the initial target color space information comprises: acquiring color blindness level corresponding to the color blindness type; and determining the first weight corresponding to the normal target color space information and the second weight corresponding to the initial target color space information according to the color blindness level.

In this embodiment, different color blindness levels correspond to different first weights and second weights, so that when the color blindness levels are different, the adjustment degrees of the normal target color space information and the initial target color space information are different, so that the obtained target color space information is more accurate.

S103: Acquire original brightness value corresponding to the RGB information.

The original brightness value refers to the brightness value corresponding to the RGB information without brightness loss. It can refer to the normal brightness value of the target color space information after the RGB information is directly converted into the target color space information, that is, the original brightness value can be V, or, when the RGB information is RGBW information, the original brightness value can also refer to W, that is, the original brightness value refers to the white light intensity value. At this time, the RGBW information can be obtained through the RGBW array image sensor.

S104: Adjust brightness value of the target color space information to acquire adjusted target color space information according to the original brightness value.

When the loss degree of the brightness value of the target color space information is small, the amplitude of the brightness adjustment may be 0. In this case, the target color space information may be directly used as the adjusted target color space information.

When the loss degree of the brightness value of the target color space information is large, the amplitude of the brightness adjustment is not 0, that is, at this time, it is necessary to perform brightness compensation on the brightness value of the target color space information to acquire the adjusted target color space information.

When the degree of loss of brightness value of the target color space information is large, when the content to be displayed is displayed according to the target RGB information obtained by converting the target color space information, the brightness of the displayed content to be displayed is inconsistent with the brightness of the content to be displayed according to the RGB information, so that the color-blind user cannot perceive the content to be displayed of the same brightness. In this embodiment, the brightness value of the target color space information is adjusted according to the original brightness value to acquire the adjusted target color space information, thereby reducing the degree of loss of the brightness value of the target color space information, so that when the content to be displayed is displayed according to the target RGB information converted from the adjusted target color space information, the brightness of the displayed content to be displayed is consistent with the brightness of the content to be displayed according to the RGB information, so that the color-blind user can perceive the content to be displayed of the same brightness as ordinary users.

In some embodiments, the degree of loss of brightness value of the target color space information can be determined by presetting a brightness threshold. At this time, the adjusting brightness value of the target color space information to acquire adjusted target color space information according to the original brightness value comprises:
acquiring a preset brightness threshold; and
adjusting brightness value of the target color space information to acquire adjusted target color space information according to the preset brightness threshold and the original brightness value.

In this embodiment, the degree of loss of the brightness value of the target color space information is judged by presetting the brightness threshold. When the degree of loss is small, the target color space information can be directly used as the adjusted target color space information. When the degree of loss is large, brightness compensation is performed on the brightness value of the target color space information to acquire the adjusted target color space information.

According to the preset brightness threshold and the original brightness value, the adjusting brightness value of the target color space information to acquire adjusted target color space information according to the preset brightness threshold and the original brightness value comprises:
determining a brightness difference between the original brightness value and the brightness value of the target color space information;
adjusting brightness value of the target color space information to acquire adjusted target color space information according to the brightness difference value and the preset brightness threshold.

In this embodiment, the degree of loss of the brightness value of the target color space information is determined by the brightness ratio between the original brightness value and the brightness value of the target color space information and a preset brightness threshold, and then the brightness of the brightness value of the target color space information is adjusted according to the degree of loss and the original brightness value to acquire the adjusted target color space information.

Alternatively, the adjusting brightness value of the target color space information to acquire adjusted target color space information according to the preset brightness threshold and the original brightness value comprises:
determining a brightness difference between the original brightness value and the brightness value of the target color space information;
adjusting brightness value of the target color space information to acquire adjusted target color space information according to the brightness difference value and the preset brightness threshold.

In this embodiment, the degree of loss of the brightness value of the target color space information is determined by the brightness difference between the original brightness value and the brightness value of the target color space information and a preset brightness threshold, and then the brightness of the brightness value of the target color space information is adjusted according to the degree of loss and the original brightness value to acquire the adjusted target color space information.

In some other implementations, brightness adjustment is performed on the brightness value of the target color space information according to the brightness difference value and the preset brightness threshold value to acquire the adjusted target color space information, including:

When the brightness difference is greater than or equal to the preset brightness threshold, brightness compensation is performed on the brightness value of the target color space information according to the original brightness value to acquire the adjusted target color space information;

When the brightness difference is less than the preset brightness threshold, the target color space information is used as the adjusted target color space information.

In this embodiment, When the brightness difference is equal to or greater than the preset brightness threshold, it means that the degree of loss of the brightness value of the target color space information is large, and brightness compensation is required for the brightness value of the target color space information. When the brightness difference is less than the preset brightness threshold, the target color space information is directly used as the adjusted target color space information.

Since the original brightness value may be a normal brightness value of the target color space information or a white light intensity value, when the original brightness value includes both the normal brightness value and the white light intensity value in the target color space information, the brightness difference value may be a brightness difference value between the normal brightness value of the target color space information and the brightness value of the target color space information. At this time, determining the brightness difference value between the original brightness value and the brightness value of the target color space information includes:

A brightness difference between a normal luminance value in the target color space information and a luminance value in the target color space information is determined.

When the brightness difference is greater than or equal to the preset brightness threshold, brightness compensation is performed on the brightness value of the target color space information according to the original brightness value to acquire the adjusted target color space information, including:

When the brightness difference is equal to the preset brightness threshold, brightness compensation is performed on the brightness value of the target color space information according to the normal brightness value to acquire the adjusted target color space information;

When the brightness difference is greater than the preset brightness threshold, brightness compensation is performed on the brightness value of the target color space information according to the white light intensity value to acquire the adjusted target color space information.

In this embodiment, since the white light intensity value is closer to the brightness of the environment where the electronic device is located, when the brightness loss is large, the brightness value of the target color space information is compensated by the white light intensity value, and the adjusted target color space information is more accurate.

In some other embodiments, the acquiring the preset brightness threshold comprises:
determining a scene type corresponding to the content to be displayed;
acquiring the preset brightness threshold corresponding to the scene type.

The scene type may refer to the scenario corresponding to the content to be displayed. For example, When the content to be displayed may be a book content, then the scene type of the content to be displayed may be a reading scene. For another example, When the content to be displayed may be a recipe, then the scene type of the content to be displayed may be a cooking scene. For another example, When the content to be displayed may be a menu, then the scene type of the content to be displayed may be an ordering scene, etc.

In this embodiment, the preset brightness thresholds of the to-be-displayed contents of different scene types are different so that brightness compensation can be performed more accurately. When the scene type is more sensitive to brightness, the preset brightness threshold is smaller, and when the scene type is less sensitive to brightness, the preset brightness threshold is larger.

In other embodiments, the adjusting brightness value of the target color space information to acquire adjusted target color space information according to the preset brightness threshold and the original brightness value comprises:
determining a threshold difference between the preset brightness threshold and the brightness value of the target color space information;
compensating the brightness value of the target color space information according to the original brightness value to acquire the adjusted target color space information when the threshold difference exceeds a preset range;
setting the target color space information as the adjusted target color space information when the threshold difference does not exceed the preset range.

In this embodiment, the loss degree of the brightness value of the target color space information is directly determined according to the preset brightness threshold, without having to determine the loss degree of the brightness value of the target color space information according to both the original brightness threshold and the preset brightness threshold.

At this time, the acquiring a preset brightness threshold comprises:
determining brightness sensitivity for the current user;
acquiring the preset brightness threshold corresponding to the brightness sensitivity.

The current user's sensitivity to brightness may be determined based on the current user's sensitivity to historical brightness, or may be determined based on the attribute group to which the current user belongs, and then the attribute group's sensitivity to brightness is used as the current user's sensitivity to brightness. This embodiment is not limited here.

In this embodiment, the preset brightness threshold is determined according to the sensitivity of the current user, so that the degree of loss of brightness value of the target color space information obtained according to the preset brightness threshold is more accurate.

S105: Convert the adjusted target color space information into target RGB information of the content to be displayed, and display the content to be displayed according to the target RGB information.

After acquiring the adjusted target color space information, the terminal converts the adjusted target color space information into target RGB information of the content to be displayed, so that the content to be displayed can be displayed according to the target RGB information.

In this embodiment, since the brightness value of the target color space information is adjusted according to the original brightness value to acquire the adjusted target color space information, the degree of loss of the brightness value of the target color space information can be reduced. Therefore, when the content to be displayed is displayed according to the target RGB information converted from the adjusted target color space information, the brightness of the displayed content to be displayed is consistent with the brightness of the content to be displayed according to the RGB information, so that the color blind user perceives the content to be displayed with the same brightness as the ordinary user.

From the above, it can be seen that in an embodiment of the present disclosure, RGB information of the content to be displayed on the electronic device is obtained, and the color blindness type of the current user of the electronic device is obtained. According to the color blindness type, the RGB information is converted into target color space information; the original brightness value corresponding to the RGB information is obtained; according to the original brightness value, the brightness value of the target color space information is adjusted to acquire the adjusted target color space information; the adjusted target color space information is converted into the target RGB information of the content to be displayed, and according to the target RGB information, the content to be displayed is displayed.

That is, in an embodiment of the present disclosure, after converting the RGB information into target color space information according to the type of color blindness, the brightness value of the target color space information is adjusted according to the original brightness value to acquire the adjusted target color space information, thereby reducing the degree of loss of the brightness value in the adjusted target color space information, so that when the content to be displayed is displayed according to the adjusted target color space information, the brightness abnormality of the content to be displayed is avoided.

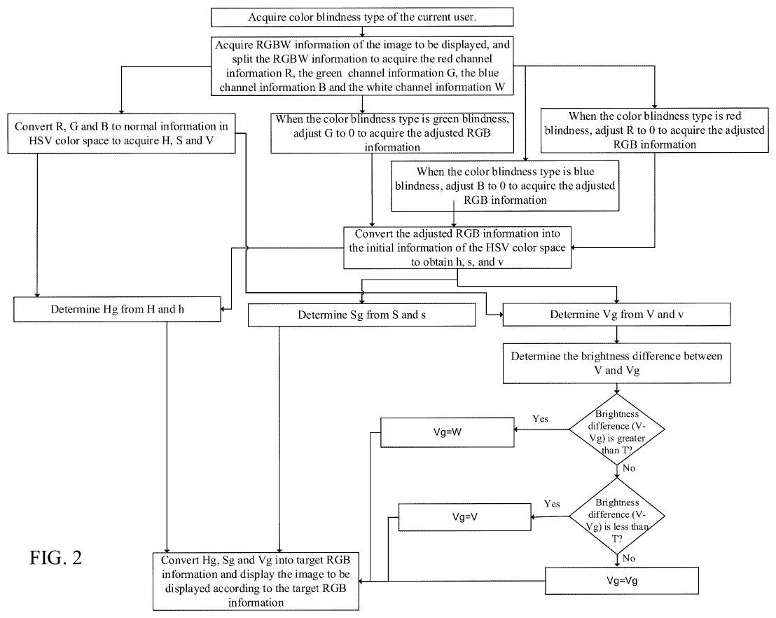

The content display method provided in the embodiment of the present disclosure is further described below with reference to FIG. 2.

Acquire the color blindness type of the current user, and acquire the RGBW information of the image to be displayed, split the RGBW information to acquire the R channel information R, the G channel information G, the B channel information B and the W channel information W, convert R, G and B into normal information in the HSV color space to acquire H (hue), S (saturation) and V (brightness value).

When the color blindness type is green blindness, adjust G to 0 to acquire the adjusted RGB information. When the color blindness type is red blindness, adjust R to 0 to acquire the adjusted RGB information. When the color blindness type is green blindness, adjust B to 0 to acquire the adjusted RGB information.

The adjusted RGB information is converted into the original information of the HSV color space to acquire h, s, and v. Hg is determined according to H and h, Sg is determined according to S and s, and Vg is determined according to V and v.

Determine the brightness difference between V and Vg. When the brightness difference (V−Vg) is greater than the preset brightness threshold T, the white light intensity value W is used as Vg. When the brightness difference (V−Vg) is equal to the preset brightness threshold T, V is used as Vg. When the brightness difference (V−Vg) is equal to the preset brightness threshold T, there is no need to adjust Vg.

Hg, Sg, and Vg are converted into target RGB information, and the image to be displayed is displayed according to the target RGB information.

In this embodiment, a preset brightness threshold is set, and the collected white light intensity value W is used to selectively compensate the brightness value under multiple conditions, so that the current user can recognize the color of the content to be displayed according to the target RGB information, and can also feel the same brightness as ordinary users.

Furthermore, when converting RGB information to HSV space, the color corresponding to the color blindness type is not directly removed, but the color is replaced by changing the color coordinates, thereby reducing the loss of RGB information.

In order to better implement the content display method provided in the embodiment of the present disclosure, the embodiment of the present disclosure also provides a device based on the above content display method. The meanings of the terms are the same as those in the above content display method, and the specific implementation details can refer to the description in the method embodiment.

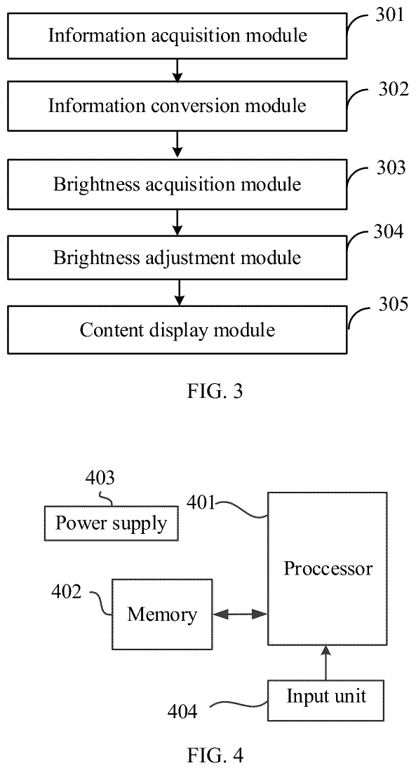

For example, as shown in FIG. 3, the content display device may include an information acquisition module 301, an information conversion module 302, a brightness acquisition module 303, a brightness adjustment module 304, and a content display module 305.

The information acquisition module 301 is used to acquire RGB information of content to be displayed by an electronic device, and to acquire the color blindness type of a current user of the electronic device.

The information conversion module 302 is used to convert the RGB information into target color space information based on the color blindness type.

The brightness acquisition module 303 is used to acquire the original brightness value corresponding to the RGB information.

The brightness adjustment module 304 is used to adjust brightness value of the target color space information to acquire adjusted target color space information according to the original brightness value.

The content display module 305 is used to convert the adjusted target color space information into target RGB information of the content to be displayed, and to display the content to be displayed according to the target RGB information.

Optionally, the brightness adjustment module 304 is specifically configured to:
acquire a preset brightness threshold;
adjust brightness value of the target color space information to acquire adjusted target color space information according to the preset brightness threshold and the original brightness value

Optionally, the brightness adjustment module 304 is specifically configured to:
determine a brightness difference between the original brightness value and the brightness value of the target color space information;
adjust brightness value of the target color space information to acquire adjusted target color space information according to the brightness difference value and the preset brightness threshold.

Optionally, the brightness adjustment module 304 is specifically configured to:
compensate the brightness value of the target color space information according to the original brightness value to acquire the adjusted target color space information when the brightness difference is greater than or equal to the preset brightness threshold;
set the target color space information as the adjusted target color space information when the brightness difference is less than the preset brightness threshold.

Optionally, the original brightness value includes a white light intensity value and a normal brightness value after RGB information is converted into a target color space.

Accordingly, the brightness adjustment module 304 is specifically configured to execute:
compensate the brightness value of the target color space information according to the normal brightness value to acquire the adjusted target color space information when the brightness difference is equal to the preset brightness threshold; and
compensate the brightness value of the target color space information according to the white light intensity value to acquire the adjusted target color space information when the brightness difference is greater than the preset brightness threshold.

Optionally, the brightness adjustment module 304 is specifically configured to:
determine a scene type corresponding to the content to be displayed; and
acquire the preset brightness threshold corresponding to the scene type.

Optionally, the brightness adjustment module 304 is specifically configured to:
determine a threshold difference between the preset brightness threshold and the brightness value of the target color space information;
compensate the brightness value of the target color space information according to the original brightness value to acquire the adjusted target color space information when the threshold difference exceeds a preset range;
set the target color space information as the adjusted target color space information when the threshold difference does not exceed the preset range.

Optionally, the brightness adjustment module 304 is specifically configured to:
determine brightness sensitivity for the current user;
acquire the preset brightness threshold corresponding to the brightness sensitivity.

Optionally, the information conversion module 302 is specifically configured to:
adjust color information corresponding to the color blindness type in the RGB information to acquire an adjusted RGB information;
convert the adjusted RGB information into initial target color space information;
convert the RGB information into normal target color space information;
determine the target color space information according to the normal target color space information and the initial target color space information.

Optionally, the information conversion module 302 is specifically configured to:
acquire a first weight corresponding to the normal target color space information and a second weight corresponding to the initial target color space information;
perform a fusion process on the first weight and the normal target color space information to acquire a first fusion result corresponding to the normal target color space information;
perform a fusion process on the second weight and the initial target color space information to acquire a second fusion result corresponding to the initial target color space information;
determine the target color space information according to the first fusion result and the second fusion result.

Optionally, the information conversion module 302 is specifically configured to:
acquire color blindness level corresponding to the color blindness type;
determine the first weight corresponding to the normal target color space information and the second weight corresponding to the initial target color space information according to the color blindness level.

Optionally, the information conversion module 302 is specifically configured to:
determine the color information corresponding to the color blindness type in the RGB information;
acquire the color blindness level corresponding to the color blindness type; and
adjust the color information corresponding to the color blindness type in the RGB information to acquire the adjusted RGB information according to the color blindness level.

In specific implementation, the above modules can be implemented as independent entities, or can be arbitrarily combined and implemented as the same or several entities. The specific implementation methods and corresponding beneficial effects of the above modules can be found in the previous method embodiments, which will not be repeated here.

The embodiment of the present disclosure further provides an electronic device, which may be a server or a terminal. As shown in FIG. 4, it shows a block diagram of the electronic device according to another embodiment of the present disclosure.

The electronic device may include components such as a processor 401 with one or more processing cores, a memory 402 with one or more computer-readable storage media, a power supply 403, and an input unit 404. Those skilled in the art will appreciate that the electronic device structure shown in FIG. 4 does not limit the electronic device, and may include more or fewer components than shown in the figure, or combine certain components, or arrange the components differently. Among them:

The processor 401 is the control center of the electronic device, which uses various interfaces and lines to connect various parts of the entire electronic device, and executes various functions of the electronic device and processes data by running or executing computer programs and/or modules stored in the memory 402, and calling data stored in the memory 402. Optionally, the processor 401 may include one or more processing cores. Preferably, the processor 401 may integrate an application processor and a modem processor, wherein the application processor mainly processes the operating system, user interface, and application programs, and the modem processor mainly processes wireless communications. It is understandable that the above-mentioned modem processor may not be integrated into the processor 401.

The memory 402 can be used to store computer programs and modules. The processor 401 executes various functional applications and data processing by running the computer programs and modules stored in the memory 402. The memory 402 may mainly include a program storage area and a data storage area, wherein the program storage area may store an operating system, a computer program required for at least one function (such as a sound playback function, an image playback function, etc.), etc.; the data storage area may store data created according to the use of the electronic device, etc. In addition, the memory 402 may include a high-speed random access memory, and may also include a non-volatile memory, such as at least one disk storage device, a flash memory device, or other volatile solid-state storage devices. Accordingly, the memory 402 may also include a memory controller to provide the processor 401 with access to the memory 402.

The electronic device also includes a power supply 403 for supplying power to each component. Preferably, the power supply 403 can be logically connected to the processor 401 through a power management system, so as to manage charging, discharging, power consumption and other functions through the power management system. The power supply 403 can also include one or more DC or AC power supplies, recharging systems, power failure detection circuits, power converters or inverters, power status indicators and other arbitrary components.

The electronic device may further include an input unit 404, which may be used to receive input digital or character information and generate keyboard, mouse, joystick, optical or trackball signal input related to user settings and function control.

Although not shown, the electronic device may further include a display unit, etc., which will not be described in detail herein. Specifically in this embodiment, the processor 401 in the electronic device will load the executable files corresponding to the processes of one or more computer programs into the memory 402 according to the following instructions, and the processor 401 will run the computer programs stored in the memory 402, thereby realizing various functions, such as:

Acquiring RGB information of content to be displayed by the electronic device, and acquiring the color blindness type of the current user of the electronic device;

According to the type of color blindness, convert RGB information into target color space information;

Acquire the original brightness value corresponding to the RGB information;

According to the original brightness value, the brightness value of the target color space information is adjusted to acquire the adjusted target color space information;

The adjusted target color space information is converted into target RGB information of the content to be displayed, and the content to be displayed is displayed according to the target RGB information.

The specific implementation methods and corresponding beneficial effects of the above operations can be found in the detailed description of the content display method above, which will not be elaborated here.

A person of ordinary skill in the art will appreciate that all or part of the steps in the various methods of the above embodiments may be completed by a computer program, or by controlling related hardware through a computer program. The computer program may be stored in a computer-readable storage medium and loaded and executed by a processor.

To this end, an embodiment of the present disclosure provides a computer-readable storage medium, in which a computer program is stored, and the computer program can be loaded by a processor to execute the steps in any content display method provided in the embodiment of the present disclosure. For example, the computer program can execute the following operations:
acquiring RGB information of content to be displayed by an electronic device, and acquiring the color blindness type of a current user of the electronic device;
converting the RGB information into target color space information based on the color blindness type;
acquiring original brightness value corresponding to the RGB information;
adjusting brightness value of the target color space information to acquire adjusted target color space information according to the original brightness value; and
converting the adjusted target color space information into target RGB information of the content to be displayed, and displaying the content to be displayed according to the target RGB information.

The specific implementation methods and corresponding beneficial effects of the above operations can be found in the previous embodiments, which will not be described in detail here.

The computer-readable storage medium may include: a read-only memory (ROM), a random access memory (RAM), a magnetic disk or an optical disk, etc.

Since the computer program stored in the computer-readable storage medium can execute the steps in any one of the content display methods provided in the embodiments of the present disclosure, the beneficial effects that can be achieved by any one of the content display methods provided in the embodiments of the present disclosure can be achieved. Please refer to the previous embodiments for details and will not be repeated here.

According to one aspect of the present disclosure, a computer program product or a computer program is provided, the computer program product or the computer program includes computer instructions, the computer instructions are stored in a computer-readable storage medium. A processor of a computer device reads the computer instructions from the computer-readable storage medium, and the processor executes the computer instructions, so that the computer device executes the above-mentioned content display method.

The above is a detailed introduction to a content display method, device, electronic device and computer-readable storage medium provided in the embodiments of the present disclosure. Specific examples are used in this article to illustrate the principles and implementation methods of the present disclosure. The description of the above embodiments is only used to help understand the method of the present disclosure and its core idea. At the same time, for technical personnel in this field, according to the ideas of the present disclosure, there will be changes in the specific implementation methods and application scopes. In summary, the content of this specification should not be understood as a limitation on the present disclosure.

1. A content display method, comprising:
acquiring RGB information of content to be displayed by an electronic device, and acquiring the color blindness type of a current user of the electronic device;
converting the RGB information into target color space information based on the color blindness type;
acquiring original brightness value corresponding to the RGB information;
adjusting brightness value of the target color space information to acquire adjusted target color space information according to the original brightness value; and
converting the adjusted target color space information into target RGB information of the content to be displayed, and displaying the content to be displayed according to the target RGB information.

2. The content display method according to claim 1, wherein the adjusting brightness value of the target color space information to acquire adjusted target color space information according to the original brightness value comprises:
acquiring a preset brightness threshold; and
adjusting brightness value of the target color space information to acquire adjusted target color space information according to the preset brightness threshold and the original brightness value.

3. The content display method according to claim 2, wherein the adjusting brightness value of the target color space information to acquire adjusted target color space information according to the preset brightness threshold and the original brightness value comprises:
determining a brightness difference between the original brightness value and the brightness value of the target color space information;
adjusting brightness value of the target color space information to acquire adjusted target color space information according to the brightness difference value and the preset brightness threshold.

4. The content display method according to claim 3, wherein the adjusting brightness value of the target color space information to acquire adjusted target color space information according to the brightness difference value and the preset brightness threshold comprises:
compensating the brightness value of the target color space information according to the original brightness value to acquire the adjusted target color space information when the brightness difference is greater than or equal to the preset brightness threshold;
setting the target color space information as the adjusted target color space information when the brightness difference is less than the preset brightness threshold.

5. The content display method according to claim 4, wherein the original brightness value includes a white light intensity value and a normal brightness value after the RGB information is converted into a target color space;
the compensating the brightness value of the target color space information according to the original brightness value to acquire the adjusted target color space information when the brightness difference is greater than or equal to the preset brightness threshold, comprises:
compensating the brightness value of the target color space information according to the normal brightness value to acquire the adjusted target color space information when the brightness difference is equal to the preset brightness threshold; and
compensating the brightness value of the target color space information according to the white light intensity value to acquire the adjusted target color space information when the brightness difference is greater than the preset brightness threshold.

6. The content display method according to claim 3, wherein acquiring the preset brightness threshold comprises:
determining a scene type corresponding to the content to be displayed;
acquiring the preset brightness threshold corresponding to the scene type.

7. The content display method according to claim 2, wherein the adjusting brightness value of the target color space information to acquire adjusted target color space information according to the preset brightness threshold and the original brightness value comprises:
determining a threshold difference between the preset brightness threshold and the brightness value of the target color space information;
compensating the brightness value of the target color space information according to the original brightness value to acquire the adjusted target color space information when the threshold difference exceeds a preset range;
setting the target color space information as the adjusted target color space information when the threshold difference does not exceed the preset range.

8. The content display method according to claim 7, wherein the acquiring a preset brightness threshold comprises:
determining brightness sensitivity for the current user;
acquiring the preset brightness threshold corresponding to the brightness sensitivity.

9. The content display method according to claim 1, wherein the converting the RGB information into target color space information according to the color blindness type comprises:
adjusting color information corresponding to the color blindness type in the RGB information to acquire an adjusted RGB information;
converting the adjusted RGB information into initial target color space information;
converting the RGB information into normal target color space information; and
determining the target color space information according to the normal target color space information and the initial target color space information.

10. The content display method according to claim 9, wherein the determining the target color space information according to the normal target color space information and the initial target color space information comprises:
acquiring a first weight corresponding to the normal target color space information and a second weight corresponding to the initial target color space information;
performing a fusion process on the first weight and the normal target color space information to acquire a first fusion result corresponding to the normal target color space information;
performing a fusion process on the second weight and the initial target color space information to acquire a second fusion result corresponding to the initial target color space information; and
determining the target color space information according to the first fusion result and the second fusion result.

11. The content display method according to claim 10, wherein the acquiring the first weight corresponding to the normal target color space information and the second weight corresponding to the initial target color space information comprises:
acquiring color blindness level corresponding to the color blindness type; and
determining the first weight corresponding to the normal target color space information and the second weight corresponding to the initial target color space information according to the color blindness level.

12. The content display method according to claim 9, wherein the adjusting color information corresponding to the color blindness type in the RGB information to acquire the adjusted RGB information comprises:
determining the color information corresponding to the color blindness type in the RGB information;
acquiring the color blindness level corresponding to the color blindness type; and
adjusting the color information corresponding to the color blindness type in the RGB information to acquire the adjusted RGB information according to the color blindness level.

13-18. (canceled)

19. An electronic device, comprising a processor and a memory storing computer program executable by the processor to perform operations comprising:
acquiring RGB information of content to be displayed by an electronic device, and acquiring the color blindness type of a current user of the electronic device;
converting the RGB information into target color space information based on the color blindness type;
acquiring original brightness value corresponding to the RGB information;
adjusting brightness value of the target color space information to acquire adjusted target color space information according to the original brightness value; and
converting the adjusted target color space information into target RGB information of the content to be displayed, and displaying the content to be displayed according to the target RGB information.

20. (canceled)

21. The electronic device according to claim 19, wherein the adjusting brightness value of the target color space information to acquire adjusted target color space information according to the original brightness value comprises:
acquiring a preset brightness threshold; and
adjusting brightness value of the target color space information to acquire adjusted target color space information according to the preset brightness threshold and the original brightness value.

22. The electronic device according to claim 21, wherein the adjusting brightness value of the target color space information to acquire adjusted target color space information according to the preset brightness threshold and the original brightness value comprises:
determining a brightness difference between the original brightness value and the brightness value of the target color space information;
adjusting brightness value of the target color space information to acquire adjusted target color space information according to the brightness difference value and the preset brightness threshold.

23. The electronic device according to claim 22, wherein the adjusting brightness value of the target color space information to acquire adjusted target color space information according to the brightness difference value and the preset brightness threshold comprises:
compensating the brightness value of the target color space information according to the original brightness value to acquire the adjusted target color space information when the brightness difference is greater than or equal to the preset brightness threshold;
setting the target color space information as the adjusted target color space information when the brightness difference is less than the preset brightness threshold.

24. The electronic device according to claim 23, wherein the original brightness value includes a white light intensity value and a normal brightness value after the RGB information is converted into a target color space;
the compensating the brightness value of the target color space information according to the original brightness value to acquire the adjusted target color space information when the brightness difference is greater than or equal to the preset brightness threshold, comprises:
compensating the brightness value of the target color space information according to the normal brightness value to acquire the adjusted target color space information when the brightness difference is equal to the preset brightness threshold; and
compensating the brightness value of the target color space information according to the white light intensity value to acquire the adjusted target color space information when the brightness difference is greater than the preset brightness threshold.

25. The electronic device according to claim 22, wherein acquiring the preset brightness threshold comprises:
determining a scene type corresponding to the content to be displayed;
acquiring the preset brightness threshold corresponding to the scene type.

26. The electronic device according to claim 21, wherein the adjusting brightness value of the target color space information to acquire adjusted target color space information according to the preset brightness threshold and the original brightness value comprises:
determining a threshold difference between the preset brightness threshold and the brightness value of the target color space information;
compensating the brightness value of the target color space information according to the original brightness value to acquire the adjusted target color space information when the threshold difference exceeds a preset range;
setting the target color space information as the adjusted target color space information when the threshold difference does not exceed the preset range.

27. The electronic device according to claim 19, wherein the converting the RGB information into target color space information according to the color blindness type comprises:
adjusting color information corresponding to the color blindness type in the RGB information to acquire an adjusted RGB information;
converting the adjusted RGB information into initial target color space information;
converting the RGB information into normal target color space information; and
determining the target color space information according to the normal target color space information and the initial target color space information.
